(19) United States
(12) Patent Application Publication
(10) Pub. No.: US 2024/0113633 A1
(43) Pub. Date: Apr. 4, 2024

(54) DC-DC CONVERTER AND POWER SUPPLY DEVICE

(71) Applicant: THINKING POWER TECHNOLOGY (SHEN ZHEN) LIMITED, Shenzhen (CN)

(72) Inventor: Zhenyuan WU, Shenzhen (CN)

(73) Assignee: THINKING POWER TECHNOLOGY (SHEN ZHEN) LIMITED, Shenzhen (CN)

(21) Appl. No.: 18/536,779

(22) Filed: Dec. 12, 2023

Related U.S. Application Data
(63) Continuation of application No. PCT/CN2022/098575, filed on Jun. 14, 2022.

(30) Foreign Application Priority Data
Jun. 15, 2021 (CN) 202110663929.2
Jun. 15, 2021 (CN) 202121328038.3

(51) Int. Cl. H02M 3/335; H02M 1/00

(52) U.S. Cl. CPC H02M 3/33573; H02M 1/0048

(57) ABSTRACT

Disclosed are a DC-DC converter and a power supply device. The converter includes: a power input end; a power output end; M bridge arm circuits; a transformer component; a rectification and filtering circuit, wherein input ends of the rectification and filtering circuit are connected to secondary winding connection ends of the transformer component, and an output end of the rectification and filtering circuit is connected to the power output end. The M bridge arm circuits and the transformer component are configured to convert the input DC power supply into the required voltage on the secondary windings of the transformer component, and the required voltages are rectified and filtered by the rectification and filtering circuit, and the filtered voltage is output to the power output end, where M is greater than or equal to 3.

### CROSS-REFERENCE TO RELATED APPLICATIONS

The present application is a continuation application of International Application No. PCT/CN2022/098575, filed on Jun. 14, 2022, which claims priority to Chinese Patent Application No. 202121328038.3, filed on Jun. 15, 2021, and Chinese Patent Application No. 202110663929.2, filed on Jun. 15, 2021. All of the aforementioned applications are incorporated herein by reference in their entireties.

### TECHNICAL FIELD

The present application relates to the technical field of a power supply, and in particular to a DC-DC converter and a power supply device.

### BACKGROUND

A traditional phase-shift full-bridge architecture adjusts an output voltage by changing a duty cycle. Referring to FIGS. 7 and 8, FIG. 7 is a schematic diagram of a circuit structure of a phase-shift full-bridge DC-DC converter, and FIG. 8 is a timing diagram of a phase-shift full-bridge DC-DC converter. The following analysis is based on the condition where the minimum current of inductor L1 is greater than zero. At time t0, the freewheeling ends, Q22 turns off, leakage inductance of the transformer begins to enter a resonant state, and the voltage at point V2 is charged. At time t1, after the voltage at point V2 reaches its highest point, Q21 is softly turned on. Q21 and Q12 work together, and the secondary side of the transformer outputs energy to the outside after rectification. At time t2, Q12 turns off. The primary side of the transformer current charges V1. At time t3, after the voltage at the point V1 reaches its highest point, Q11 is softly turned on. The output voltage of the transformer is 0. The transformer Tx₁ Q11, and Q21 enter the freewheeling state. Energy is wasted in the transistors and transformer windings in this state. At time t4, freewheeling ends, Q21 turns off, and the leakage inductance of the transformer begins to enter the resonant state, discharging the voltage at point V2. At time t5, after the voltage at point V2 reaches its lowest point, Q22 is softly turned on. Q22 and Q11 work together, and the secondary side of the transformer outputs energy to the outside after rectification. At time t6, Q11 turns off. The primary side current of the transformer discharges the voltage at point V1. At time t7, after the voltage at point V1 reaches its lowest point, Q12 is softly turned on. The output voltage of the transformer is 0. The transformer Tx₁ Q12 and Q22 enter the freewheeling state. Energy is wasted in the transistors and transformer windings in this state.

To cope with instantaneous changes in load, the transformer cannot work at full duty cycle, resulting in the introduction of freewheeling loss.

### SUMMARY

The main purpose of the present application is to propose a DC-DC converter and a power supply device, aiming to reduce the resistive loss in the bridge arm circuit and the transformer, particularly the freewheeling loss.

To achieve the aforementioned purpose, the present application proposes a DC-DC converter. The DC-DC converter includes a power input end, a power output end, M bridge arm circuits, a transformer component and a rectification and filtering circuit.

The power input end is configured to be connected to a DC power supply.

The power output end is configured to output power.

The input end of M bridge arm circuits is connected to the power input end.

The transformer component includes (M-1) transformers, and the (M-1) transformers are provided with at least 2 transformers with different turns ratios. Each of the transformers includes two primary winding connection ends. One of the primary winding connection ends of the Nth transformer is connected to the bridge arm center point of the Nth bridge arm circuit, and the other primary winding connection end of the Nth transformer is connected to the bridge arm center point of the (N+1)th bridge arm circuit, where 1≤N≤(M-1).

The input ends of the rectification and filtering circuit are connected to the secondary winding connection ends of the transformer component. The output end of the rectification and filtering circuit is connected to the power output end.

In this configuration, the M bridge arm circuits and the transformer component are configured to convert the incoming DC power supply into the required voltages on the secondary windings of the transformer component. The required voltages are rectified and filtered by the rectification and filtering circuit, the filtered voltage is provided to the power output end, where M≥3.

In an embodiment, the states of two adjacent transformers are simultaneously changed by altering the status of the switches in the bridge arm circuit to which the two adjacent transformers are commonly connected.

In an embodiment, when one of the (M-1) transformers with at least one end floating starts to operate, the bridge arm circuit in which the magnetizing current flows out in the two bridge arm center points connected to the primary winding connection ends turns on the lower switch, while the bridge arm circuit in which the magnetizing current flows into in the two bridge arm center points connected to the primary winding connection ends turns on the upper switch, in order to minimize the switching loss in the bridge arm circuits.

In an embodiment, when one of the (M-1) transformers with at least one end floating starts to operate, the bridge arm circuit in which the magnetizing current flows out in the two bridge arm center points connected to the primary winding connection ends turns on the lower switch, while the bridge arm circuit in which the magnetizing current flows into in the two bridge arm center points connected to the primary winding connection ends turns on the upper switch, in order to minimize the switching loss in the bridge arm circuits. Meanwhile, the other transformer that is already connected to the DC power supply remains the same switch state and continues to operate, allowing the two transformers to be simultaneously connected to the DC power supply.

In an embodiment, the DC-DC converter operates in an alternate phase-shift full-bridge mode. In this alternate phase-shift full-bridge mode:
the (M-1) transformers on the primary side operate sequentially for one or more control periods with the DC power supply voltage and zero voltage, and/or
within one control period, one of the transformers first operates by connecting to the DC power supply through the corresponding bridge arms, and then short-circuits both ends of the transformer through the corresponding bridge arms. This transformer operate in this manner for one or more control periods. The (M-1) transformers operate in a cyclic sequence.

In an embodiment, the DC-DC converter operates in a dual-way mode. In the dual-way mode:
within one control period, from the first transformer to the (M-1)th transformer, they operate sequentially with the DC power supply voltage, and then the (M-1)th transformer freewheels with zero voltage; and/or
within one control period, the (M-1) transformers start a loop from any one of the transformers, operate sequentially by connecting to the corresponding bridge arm with the DC power supply, and after the loop, the last transformer short-circuits the two ends of the last transformer through the corresponding bridge arm and freewheels.

In an embodiment, in a dual-way mode, when switching to the operation of the last transformer, the last two transformers simultaneously connect to the DC power supply and operate.

In an embodiment, the DC-DC converter operates in a semi-integrated mode. In the semi-integrated mode, within one control period, the first transformer to the (M-1)th transformer operate sequentially with the DC power supply voltage, and then the (M-1) transformers simultaneously operate; and/or
in the semi-integrated mode, within one control period, the (M-1) transformers initiate a cycle starting from any one of the transformers, and sequentially connect to the DC power supply through the corresponding bridge arms; at the end of the control period, all the (M-1) transformers work in serial.

In an embodiment, in the semi-integrated mode, when switching to the operation of the last transformer, the last two transformers simultaneously connect to the DC power supply.

In an embodiment, the DC-DC converter operates in a fully-integrated mode. In the fully-integrated mode:
within one control period, the first transformer to the (M-1)th transformer operate sequentially with the DC power supply voltage; and/or
within one control period, the (M-1) transformers start a loop from any one of the transformers, and operate sequentially by connecting to the DC power supply through the corresponding bridge arm.

In an embodiment, in the fully-integrated mode, the control period is adjusted based on changes in the input voltage and the duty cycle of each transformer, to ensure that the maximum magnetic flux in any one of the (M-1) transformers does not exceed the maximum allowable value of the magnetic material; and/or
when switching to the operation of the last transformer, the last two transformers simultaneously connect to the DC power supply.

In an embodiment, the DC-DC converter operates in four modes: the alternate phase-shift full-bridge mode, the dual-way mode, the semi-integrated mode, and the fully-integrated mode.

In alternate phase-shift full-bridge mode, the primary sides of the (M-1) transformers sequentially operate for one or more control periods with the DC power supply voltage and zero voltage.

In dual-way mode, within one control period, the primary sides of the first transformer to the (M-1)th transformer operate sequentially with the DC power supply voltage, and then the (M-1)th transformer freewheels with zero voltage.

In semi-integrated mode, within one control period, the first transformer to the (M-1)th transformer sequentially operate with the DC power supply voltage, and then the (M-1) transformers simultaneously operate in series.

In fully-integrated mode, within one control period, the first transformer to the (M-1)th transformer sequentially operates with the DC power supply voltage.

The DC-DC converter also includes a main controller, and the main controller is connected to the controlled ends of the bridge arm switches in the M bridge arm circuits. The main controller is configured to control the on/off of the corresponding bridge arm switches in the M bridge arm circuits during the operation of the DC-DC converter, allowing the transformer component to operate in one of the alternate phase-shift full-bridge mode, dual-way mode, semi-integrated mode, and fully-integrated mode or combinations of these modes.

In an embodiment, in the dual-way mode, semi-integrated mode, or fully-integrated mode, when switching to the operation of the last transformer, the last two transformers simultaneously connect to the DC power supply.

In an embodiment, in the fully-integrated mode, the control period is adjusted based on changes in the input voltage and the duty cycle of each transformer to ensure that the maximum magnetic flux in any one of the (M-1) transformers does not exceed the maximum allowable value of the magnetic material.

In an embodiment, the switching between any two modes has a hysteresis with the changes in the equivalent full-bridge duty cycle.

In an embodiment, the DC-DC converter operates in an alternate full-bridge mode. In this alternate full-bridge mode, within one control period, one of the (M-1) transformers first connects to the DC power supply through the corresponding bridge arm, and then all the bridge arms connected to the transformer are turned off, causing the input end of the transformer to float. The transformer operates in this manner for one or more control periods, and the (M-1) transformers work in a cyclic sequence.

In an embodiment, the DC-DC converter operates in a standalone full-bridge mode. In this standalone full-bridge mode, only one of the (M-1) transformers operates. Within one control period, the transformer first connects to the DC power supply through the corresponding bridge arm, and then all the bridge arms connected to the transformer are turned off, causing the input end of the transformer to float.

In an embodiment, the DC-DC converter operates in a standalone phase-shift full-bridge mode. In this standalone phase-shift full-bridge mode, only one of the (M-1) transformers operates. Within one control period, the transformer first connects to the DC power supply through the corresponding bridge arm, and then operates by short-circuiting the two ends of the transformer through the corresponding bridge arm.

In an embodiment, in the standalone phase-shift full-bridge mode, among all the transformers where the voltage output after rectification is greater than the voltage at the power output end, the transformer currently in operation has the highest turns ratio.

The transformer having the maximum turns ratio implies that its rectified output voltage is the smallest. This allows the use of rectifier components with the minimum voltage rating and the maximum duty cycle. Using components with the minimum voltage rating results in cost savings or improved efficiency. Having the maximum duty cycle means the shortest free-wheeling time, minimizing energy waste during free-wheeling.

In another embodiment, the DC-DC converter operates in at least one of the following modes: standalone phase-shift full-bridge mode, standalone full-bridge mode, alternate full-bridge mode, alternate phase-shift full-bridge mode, dual-way mode, semi-integrated mode, and fully-integrated mode.

In the standalone phase-shift full-bridge mode, only one of the (M-1) transformers operates within one control period. The transformer first connects to the DC power supply through the corresponding bridge arm, and then operates by short-circuiting the two ends of the transformer through the corresponding bridge arm.

In the standalone full-bridge mode, only one of the (M-1) transformers operates within one control period. The transformer first connects to the DC power supply through the corresponding bridge arm, and then all the bridge arms connected to the transformer are turned off, causing the input end of the transformer to float.

In the alternate full-bridge mode, within one control period, one of the (M-1) transformers operates first by connecting to the DC power supply through the corresponding bridge arm, and then all the bridge arms connected to the transformer are turned off, causing the input end of the transformer to float. The transformer operates in this manner for one or more control periods, and then the (M-1) transformers cyclically operate in sequence.

In the alternate phase-shift full-bridge mode, within one control period, one of the transformers operates first by connecting to the DC power supply through the corresponding bridge arm, and then operates by short-circuiting the two ends of the transformer through the corresponding bridge arm. The transformer operates in this manner for one or more control periods, and then the (M-1) transformers cyclically operate in sequence.

In dual-way mode, within a control period, (M-1) transformers initiate a cycle from any one of the transformers, sequentially operating by connecting to the DC power supply through the corresponding bridge arm. At the end of the control period, the last transformer freewheels by short-circuiting both ends through the corresponding bridge arm.

In the semi-integrated mode, within one control period, the (M-1) transformers start a cycle from any one of the transformers and sequentially connect to the DC power supply through the corresponding bridge arm. After the cycle, the (M-1) transformers work in series simultaneously.

In the fully-integrated mode, within one control period, the (M-1) transformers initiate a cycle starting from any one of the transformers, and sequentially connect to the DC power supply through their corresponding bridge arms.

The DC-DC converter further includes a main controller, which is connected to the controlled ends of the bridge arm switches in M bridge arm circuits. The main controller is configured to control the on/off status of the corresponding bridge arm switches in the M bridge arm circuits during the operation of the DC-DC converter, allowing the transformer component to operate in one of standalone full-bridge mode, standalone bridge arm mode, alternate full-bridge mode, alternate phase-shift full-bridge mode, dual-way mode, semi-integrated mode, and fully-integrated mode or a combination of these modes.

In an embodiment, in the dual-way mode, the semi-integrated mode or the fully-integrated mode, when switching to the last transformer to operate, the last two transformers simultaneously connect to the DC power supply to operate.

In an embodiment, in the fully-integrated mode, the control period is adjusted based on changes in the input voltage and the duty cycle of each transformer to ensure that the maximum magnetic flux of any one of the (M-1) transformers does not exceed the maximum allowable value of the magnetic material.

In an embodiment, the switching between any two modes has a hysteresis associated with changes in the equivalent full-bridge duty cycle.

In an embodiment, when M is equal to 3, three bridge arm circuits include the first bridge arm switch, the second bridge arm switch, the third bridge arm switch, the fourth bridge arm switch, the fifth bridge arm switch, and the sixth bridge arm switch.

The first bridge arm switch and the second bridge arm switch are connected in series to form the first bridge arm circuit.

The third bridge arm switch and the fourth bridge arm switch are connected in series to form the second bridge arm circuit.

The fifth bridge arm switch and the sixth bridge arm switch are connected in series to form the third bridge arm circuit.

In an embodiment, in the alternate phase-shift full bridge mode, the main controller, when controlling the two bridge arm switches in the second bridge arm circuit to turn on/off, controls the two bridge arm switches in either the first bridge arm circuit or the third bridge arm circuit to turn on/off, and controls the two bridge arm switches in the other bridge arm circuit to turn off.

In an embodiment, in the dual-way mode, the main controller controls the second bridge arm switch to turn off first and controls the fifth bridge arm switch to turn on later; controls the first bridge arm switch to turn off first and controls the sixth bridge arm switch to turn on later; the main controller controls the second bridge arm switch to turn on first and controls the sixth bridge arm switch to turn off later; controls the first bridge arm switch to turn on first and controls the fifth bridge arm switch to turn off later.

In an embodiment, in the semi-integrated mode or the fully-integrated mode, the main controller controls the third bridge arm switch to turn on first and controls the first bridge arm switch to turn off later; controls the fourth bridge arm switch to turn on first and controls the second bridge arm switch to turn off later. The main controller controls the second bridge arm switch to turn on first and controls the sixth bridge arm switch to turn off later; controls the first bridge arm switch to turn on first and controls the fifth bridge arm switch to turn off later. The main controller controls the fifth bridge arm switch to turn on first and controls the fourth bridge arm switch to turn on later; controls the sixth bridge arm switch to turn on first and controls the third bridge arm switch to turn on later.

The present application also proposes a power supply device including the DC-DC converter as described above.

The DC-DC converter in the present application is provided with M bridge arm circuits, a transformer component and a rectification and filtering circuit between the power input and power output ends. By using the M bridge arm circuits and the transformer component, the incoming DC power is converted into the required voltage and then rectified and filtered before being output to the power output end.

During the operation of the DC-DC converter, the various transformers in the transformer component are operated in coordination with the on/off of the bridge arm switches in the various bridge arm circuits in a timed sequence. They operate alternately and/or simultaneously according to a certain time ratio, the residual energy of leakage inductance and magnetizing current of the transformer is utilized to charge and discharge, reducing the loss when the bridge arm switches are turned on.

Conventional phase-shift full-bridge architectures adjust the output voltage by changing the duty cycle, but in order to respond to instantaneous change in load, they cannot operate at full duty cycle, which introduces free-wheeling loss. The present application reduces the resistive loss in the bridge arm circuit and the transformer, especially free-wheeling loss, thereby reducing the size of heat sink of the DC-DC converter, which is beneficial for energy conservation and emission reduction.

### BRIEF DESCRIPTION OF THE DRAWINGS

In order to provide a clearer explanation of the technical solutions in the embodiments of the present application or in the related art, the following will briefly introduce the accompanying drawings that are needed in the descriptions of the embodiments or the related art. It is obvious that the accompanying drawings described below are only some embodiments of the present application. For those skilled in the art, other drawings can be obtained based on the structures shown in these drawings without creative efforts.

FIG. 1 is a schematic diagram of a circuit structure of a DC-DC converter according to an embodiment of the present application.

FIG. 2 is a schematic diagram of the circuit structure of the DC-DC converter according to another embodiment of the present application.

FIG. 3 is a timing diagram of the DC-DC converter operating in a alternate phase-shift full-bridge mode according to the present application.

FIG. 4 is a timing diagram of the DC-DC converter operating in a dual-way mode according to the present application.

FIG. 5 is a timing diagram of the DC-DC converter operating in a semi-integrated mode according to the present application.

FIG. 6 is a timing diagram of the DC-DC converter operating in a fully-integrated mode according to the present application.

FIG. 7 is a schematic diagram of the circuit structure of an existing phase-shift full-bridge architecture DC-DC converter.

FIG. 8 is a timing diagram of the phase-shift full-bridge architecture DC-DC converter in FIG. 7.

The realization of the purpose, functional characteristics, and advantages of the present application will be further explained with reference to the embodiments and in conjunction with the accompanying drawings.

### DETAILED DESCRIPTION OF THE EMBODIMENTS

The following will provide a clear and comprehensive description of the technical solution in the embodiments of the present application, with reference to the drawings in the embodiments of the present application. It is evident that the described embodiments are only some rather than all of the embodiments of the present application. Based on the embodiments in the present application, all other embodiments that those skilled in the art can obtain without creative efforts fall within the scope of the present application.

It should be noted that if there are directional terms (such as up, down, left, right, front, rear, etc.) in the embodiments of the present application, these directional terms are only intended to explain the relative positional relationships and movements between components in a specific posture (as shown in the drawings). If this specific posture changes, the directional terms will also change accordingly.

Additionally, if the embodiments of the present application include descriptions like “first,” “second,” etc., these descriptions are used for the purpose of description and should not be construed as indicating or implying relative importance or implicitly indicating the quantity of the indicated technical features. Therefore, features defined with “first,” “second,” etc., may explicitly or implicitly include at least one such feature.

Furthermore, the technical solutions in the embodiments can be combined, provided that such combinations are achievable by those skilled in the art. When the combination of technical solutions results in mutual contradictions or cannot be realized, such a combination should be considered non-existent and is not within the scope of the present application.

In this document, the term “and/or” is used to describe the association relationship between related objects, indicating that there can be three relationships. For example, “A and/or B” can represent three situations: A solution, solution including A and B, and B solution.

Additionally, in this document, the character “I” generally indicates that the associated objects is an “or” relationship.

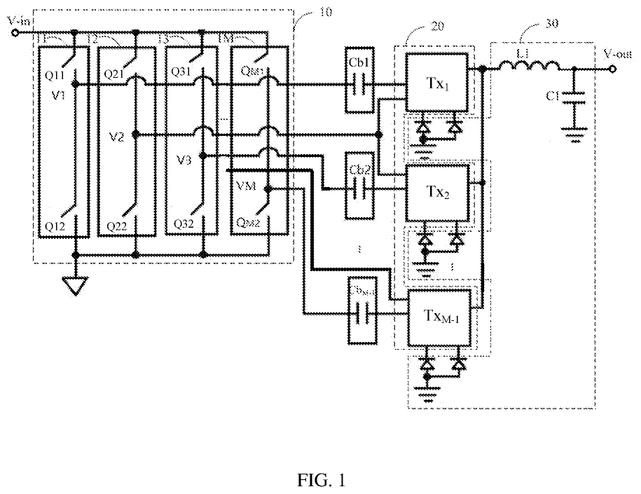

The present application proposes a DC-DC converter. Referring to FIGS. 1 to 6, in an embodiment of the present application, the DC-DC converter includes: a power input end V-in, a power output end V-out, M bridge arm circuits 10, a transformer component 20 and a rectification and filtering circuit 30.

The power input end V-in is configured to be connected to a direct current (DC) power supply.

The power output end V-out is configured to output power.

The input end of the M bridge arm circuits is connected to the power input end V-in. Each bridge arm circuit includes two switch transistors, with two switch transistors in series connection. These bridge arm circuits are connected in parallel. The switch transistors can be implemented using power transistors such as MOSFETs, IGBTs, GANFETs, SiCFETs, etc.

The primary winding connection ends of each transformer of the transformer component are connected to the center points of the M bridge arm circuits.

The transformer component 20 includes (M-1) transformers Tx₁˜Tx_{M-1}. Among these (M-1) transformers, at least two of them have different turns ratios. Each of these transformers includes two primary winding connection ends. One of the primary winding connection ends of the Nth transformer is connected to the center point of the Nth bridge arm circuit, and the other primary winding connection end of the Nth transformer is connected to the center point of the (N+1)th bridge arm circuit, where 1≤N≤(M-1).

Specifically, the first transformer has one of the primary winding connection ends connected to the center point of the first bridge arm circuit and the other primary winding connection end connected to the center point of the second bridge arm circuit.

The second transformer has one of the primary winding connection ends connected to the center point of the second bridge arm circuit and the other primary winding connection end connected to the center point of the third bridge arm circuit.

This pattern continues, with one of the primary winding connection ends of the (M−1)th transformer connected to the center point of the (M-1)th bridge arm circuit and the other primary winding connection end connected to the center point of the Mth bridge arm circuit.

It's important to note that the connections mentioned here refer to electrical connections, and the present application does not impose restrictions on the physical connection methods used for connecting the primary winding ends of adjacent transformers and the corresponding bridge arm center points.

The transformer windings of the transformer component 20 can be set to either step-down or step-up voltage transformation.

The rectification and filtering circuit 30 has input ends connected to the secondary winding connection ends of the transformer component 20, and an output end connected to the power output end. The rectification and filtering circuit 30 can be implemented using components such as rectification diodes, inductors, capacitors, and so on.

Specifically, in the DC-DC converter, on the secondary windings of the transformer component, which is an output side, diodes are provided for rectification. The diodes can also be parasitic diodes of a synchronous rectification transistors. The specific configuration and connection of the diodes in the circuit can be adjusted adaptively according to the actual application without any specific limitation.

On the output side of the DC-DC converter, an inductor (L1) and a capacitor (C1) are provided. The inductor (L1) is connected in series between the secondary winding connection end or the output end of the rectification diode and the power output end (V-out), and the capacitor (C1) is connected to the power output end (V-out).

The M bridge arm circuits 10, in conjunction with the transformer component 20, is configured to convert the incoming DC power supply voltage into the required voltages on the secondary windings of the transformer component 20. The required voltages are rectified and filtered by the rectification and filtering circuit 30, and the filtered voltage is output to the power output end. It's worth noting that, in this configuration, the value of M should be equal to or greater than 3.

The DC-DC converter in the present application is provided with M bridge arm circuits 10, the transformer component 20 and the rectification and filtering circuit 30 between the power input end V-in and the power output end V-out. The M bridge arm circuits, in conjunction with the transformer component, convert the incoming DC power supply into the required voltage, and the output is further rectified and filtered through the rectification and filtering circuit before being supplied to the power output end.

During the operation of the DC-DC converter, the various transformers in the transformer component work in coordination with the bridge arm switches of the different bridge arm circuits being turned on and off in a specific time sequence. They operate alternately or simultaneously with a certain time ratio. This approach makes use of the residual energy and magnetizing current of the transformers for charging and discharging, thereby reducing loss when the bridge arm switches are turned on.

Existing phase-shift full-bridge architectures adjust the output voltage by changing the duty cycle. However, they are unable to operate at full duty cycle to cope with instantaneous changes in load, which results in extra conduction loss. The present application reduces resistive loss, particularly conduction loss, in the bridge arm circuits and transformers. This reduction results in smaller heat sink sizes, contributing to improved energy efficiency and reduced emissions.

In an embodiment, during one control period, multiple transformers operate alternately to reduce the maximum magnetic flux of a single transformer.

The traditional single-transformer architecture reduces the maximum magnetic flux of the transformer by increasing the switching frequency. By doubling the switching frequency, it is possible to halve the primary and secondary turns while maintaining a fixed turns ratio and maximum magnetic flux. This achieves the goal of reducing winding resistive losses.

Compared to the single-transformer architecture, this architecture can replace the transformer in the single-transformer architecture by having two transformers with halved primary and secondary turns working alternately, while still maintaining the original maximum magnetic flux. After reducing the turns of both the primary and secondary by half, the volume of each transformer is correspondingly reduced by about 40%. The total volume of all transformers will only increase by approximately 20%. By slightly increasing the volume, the use of multiple transformers operating alternately not only reduces the resistive losses in the transformer windings but also allows for the controlled management of the maximum magnetic flux for each transformer, as well as the overall magnetic losses.

In an embodiment, magnetic cores of two transformers in the transformer component are connected together. Connecting the magnetic cores together can maximize the saving of physical space.

In an embodiment, the DC-DC converter operates in a proximity mode,
in the proximity mode, during one control period, when the voltage at the power output end falls between rectified voltages of any two of the (M-1) transformers, these two transformers operate alternately; and/or,
in the proximity mode, during one control period, when the voltage at the power output end is lower than the rectified voltages of all transformers among the (M-1) transformers, the transformer with the minimum rectified voltage operates.

When the voltage at the power output end falls between rectified voltages of any two of the (M-1) transformers, these two transformers operate alternately. When these two transformers work alternately, apart from conduction losses in the magnetizing current, there are no other free-wheeling losses. Adjusting the duty cycles of these two transformers can generate any voltage value between the rectified voltages of these two transformers.

When the voltage at the power output end is lower than the rectified voltages of all transformers among the (M-1) transformers, the transformer with the minimum rectified voltage operates. The operation of the transformer with the minimum rectified voltage allows the use of rectifier components with the minimum voltage rating and the maximum duty cycle in continuous conduction mode. Using rectifier components with the minimum voltage rating means cost savings or improved efficiency. Having the maximum duty cycle means the shortest free-wheeling time, minimizing energy waste during free-wheeling.

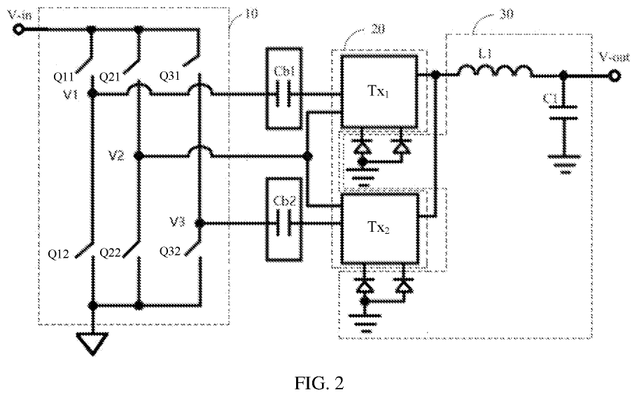

By changing the states of the switches in the bridge arm circuit shared by two adjacent transformers, it is possible to simultaneously alter the states of these two adjacent transformers. Referring to FIG. 2, in an embodiment, in the initial state, Q11 is turned on, Q12 is turned off, Q21 is turned off, Q22 is turned on, Q31 is turned off, and Q32 is turned on. In an ideal scenario, the voltage across the ends of Tx₁ is equal to the DC power supply voltage, while the voltage across the ends of Tx₂ is zero.

Without changing the states of Q11 and Q12, Q22 turns off, and Q21 turns on after a dead time. In an ideal situation, the voltage across the ends of Tx₁ becomes zero, and the voltage across the ends of Tx₂ becomes equal to the DC power supply voltage.

When one of the (M-1) transformers with at least one end floating starts to operate, the bridge arm circuit in which the magnetizing current flows out in the center point of the two bridge arms connected to the primary winding connection ends turns on the lower switch, while the bridge arm circuit in which the magnetizing current flows into in the center point of the two bridge arms connected to the primary winding connection ends turns on the upper switch, in order to minimize the switching loss in the bridge arm circuits.

Referring to FIG. 2, in an embodiment, in the initial state, Tx₂ is operating, Q11 is turned off, Q12 is turned off. The magnetizing current of Tx₁ flows out from the point V1 and flows into the point V2. Since both Q11 and Q12 associated with the point V1 are turned off, V1 is in a floating state, and voltage at the point V1 continuously decreases as the magnetizing current of Tx₁ discharges. As the voltage at the point V1 decreases, the switching loss caused by turning on Q12 decreases.
when one of the (M-1) transformers with at least one end floating starts to operate, the bridge arm circuit in which the magnetizing current flows out in the center point of the two bridge arms connected to the primary winding connection ends turns on the lower switch, while the bridge arm circuit in which the magnetizing current flows into in the center point of the two bridge arms connected to the primary winding connection ends turns on the upper switch, in order to minimize the switching loss in the bridge arm circuits. Meanwhile, another transformer that is already connected to the DC power supply remains the same switch state and continues to operate, allowing both transformers to be simultaneously connected to the DC power supply.

Referring to FIG. 1, in an embodiment, in the initial state, Tx₂ is operating, Q11 is turned off, Q12 is turned off, Q21 is turned on, Q22 is turned off, Q31 is turned off, and Q32 is turned on. Tx₂ is connected and operating with the DC power supply. The magnetizing current of Tx₁ flows out from the point V1 and flows into the point V2. Because both Q11 and Q12 associated with the point V1 are turned off, V1 is in a floating state, and the voltage at the point V1 continuously decreases as the magnetizing current of Tx₁ discharges. As the voltage at the point V1 decreases, the switching loss caused by turning on Q12 will decrease. After turning on Q12, transformers Tx₁ and Tx₂ work simultaneously.

In an embodiment, two adjacent transformers with different turns ratio of the (M-1) transformers are simultaneously connected to the DC power supply, the transformer with the large turns ratio conducts all or most of the current,
maintain the state for a period of time, so that one bridge arm circuit, which is connected to the primary winding of the transformer with the large turns ratio, is turned off with smaller current to decrease the switching loss.

The transformer with a higher turns ratio has a smaller rectified output voltage, while the transformer with a lower turns ratio has a larger rectified output voltage. For the transformer with a lower turns ratio, both the primary and secondary current continuously increases under the combined influence of voltage difference and leakage inductance. Conversely, for the transformer with a higher turns ratio, both the primary and secondary current continuously decreases under the combined influence of voltage difference and leakage inductance. If given enough time, the primary current of the transformer with a higher turns ratio will decrease to the magnetizing current, and the secondary current will reduce to zero.

In an embodiment, one transformer is operating at a DC power supply voltage and delivering energy externally, the two primary winding connection ends of the transformer adjacent to the one transformer are short-circuited through the bridge arm circuits, the transformer adjacent to the one transformer and one bridge arm circuit connected to the transformer are in a state of magnetizing current freewheeling, turn-off of the corresponding switch in the bridge arm circuit is controlled and the magnetizing current of the adjacent transformer is utilized to charge and discharge the parasitic capacitor at the floating end, thereby reducing the switching loss of the bridge arm circuit when switching to the adjacent transformer.

The magnetizing current of the adjacent transformer is very small, and the turn-off loss is basically zero when the corresponding bridge circuit switch is turned off. This magnetizing current charges and discharges the parasitic capacitance at the floating end. In the most ideal scenario, the parasitic diode connected to this floating end conducts, or the secondary rectified output voltage of the adjacent transformer is equal to the rectified output voltage of the transformer in operation. The final effect depends on the magnitude of the magnetizing current and the charging and discharging time.

The turn-off time of the corresponding switch of the bridge arm circuit is controlled by the magnetizing current of the adjacent transformer. When the node capacitance is fixed, a larger magnetizing current results in a shorter charge/discharge time, while a smaller magnetizing current leads to a longer charge/discharge time.

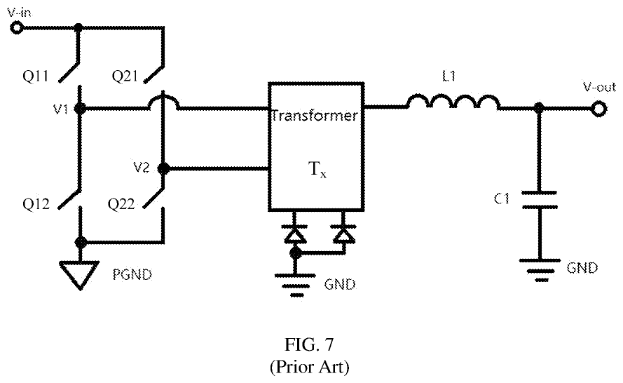

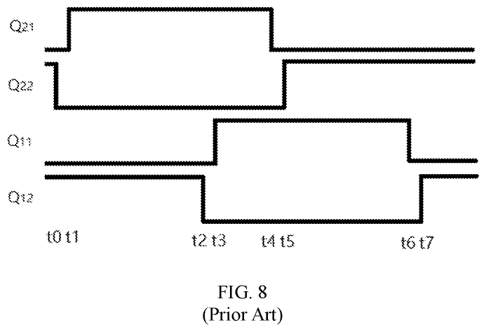

Referring to FIGS. 7 to 8, in the traditional phase-shift full-bridge DC-DC converter, the transformer Tx has the primary winding with a turn of 2 kN and the secondary winding with a turn of 2k. Taking into account magnetic flux balance, the formula for calculating the maximum magnetic flux Bₘₐₓ in the transformer Tx of the traditional phase-shift full-bridge DC-DC converter is as follows:

$${B}_{max} = \frac{( V BUS * D * T )}{2 kN * Ae * 2}$$

Where, VBUS is the direct current supply voltage, D is the equivalent duty cycle of the full-bridge transformer Tx, T is the switching period of the full-bridge DC-DC converter, 2 kN is the number of turns in the primary winding of the full-bridge transformer Tx, Ae is the equivalent cross-sectional area of the full-bridge transformer.

Referring to FIGS. 1 to 6, in an embodiment, where M is equal to 3, there is a three-bridge architecture with three bridge arm circuits, and the number of matched transformers is two. These two transformers Tx₁ and Tx₂ can operate either with the same magnetic flux or in an asymmetric magnetic flux manner, as long as it ensures that the maximum magnetic flux does not exceed the maximum magnetic flux of the transformer material.

In the case of the three-bridge transformer Tx₁, while keeping the equivalent cross-sectional area of a magnetic core of the new transformer unchanged, namely, Ae₁=Ae. The magnetic core of the full-bridge transformer is split in half. This means that half of the primary and secondary windings are placed in half of the space, and the magnetic circuit is added along the cross-section. The turns in the primary and secondary windings of the three-bridge transformer are kN and k, respectively, which reduces the resistance by half compared to the full-bridge transformer.

The three-bridge transformer Tx₂ utilizes the same magnetic core as the transformer Tx₁. The number of turns in the primary winding and the secondary winding can be adjusted to pkN and k, respectively, where P is greater than or equal to 1.

Taking into account magnetic flux balance, the formula for calculating the maximum magnetic flux B₁ₘₐₓ in the transformer Tx₁ of the three-bridge architecture DC-DC converter is as follows:

$${B}_{1 max} = \frac{( V BUS * {D}_{1} * T )}{kN * {Ae}_{1} * 2} = \frac{( V BUS * {D}_{1} * T )}{kN * Ae * 2}$$

Where:
VBUS is the direct current supply voltage.
D₁ is the equivalent duty cycle of the transformer Tx₁.
T is the switching period of the three-bridge DC-DC converter.
kN is the number of turns in the primary winding of the transformer Tx₁.
Ae and Ae₁ are the equivalent cross-sectional areas of transformers Tx and Tx₁, respectively.

When

$${D}_{1} = \frac{D}{2} ,$$

B₁ₘₐₓ=Bₘₐₓ, the maximum magnetic flux in the three-bridge transformer Tx₁ remains consistent with that of the full-bridge transformer Tx₁ allowing the three-bridge transformer to operate normally.

In the case where the steady-state inductor current is greater than zero, when D is relatively small, Tx₂ only needs to operate with a duty cycle D2 after Tx₁. Here, D₂=p(D−D₁), and it should satisfy the condition that D1+D2 is less than or equal to 1. In this scenario, the total equivalent output of these two transformers is the same as that of a traditional full-bridge transformer. When D1+D2 is equal to 1, it enters a fully-integrated mode. As D continues to increase, in order to maintain the same effect as the traditional full bridge, D1 will be greater than D/2, and D2 will be equal to 1−D1. Consequently, a situation arises where the maximum magnetic flux of transformers Tx₁ and Tx₂ is not the same, and the maximum magnetic flux for each transformer must be controlled within the allowable range of the magnetic materials for the transformer.

Under steady-state conditions and with the same output voltage and current, the three-bridge converter and the full-bridge converter have the same inductor current. To facilitate comparison, the three-bridge converter and the full-bridge converter use transistors with the same resistance values.

The resistance of the primary winding in the three-bridge transformer Tx₁ is half that of the full-bridge transformer Tx. Because the inductor current and turn ratio in the three-bridge transformer Tx₁ are the same as that in the full-bridge transformer when operating independently, the primary current is also the same. The instantaneous resistive loss in the primary winding when the three-bridge transformer Tx₁ operates independently is half that of the full-bridge transformer, and the instantaneous resistive loss of the transistors is the same as that of the full-bridge converter.

In the three-bridge transformer Tx₁, when the same primary winding space is filled with p times windings, the winding will inevitably become thinner, with the cross-sectional area that is 1/p of the original one. The primary resistance is 0.5*p² times that of the full-bridge

P transformer Tx. Since the three-bridge converter and the full-bridge converter have the same inductor current, the turns ratio of the three-bridge transformer Tx₂ is p times that of the full-bridge transformer Tx. Therefore, when the three-bridge transformer Tx₂ operates independently, the primary current is 1/p times that of the full-bridge transformer Tx. The instantaneous resistive loss in the primary winding of the three-bridge transformer Tx₂ when operating independently is

$${( \frac{1}{p} )}^{2} * ( 0.5 * {p}^{2} ) = 0.5$$

times that of the full-bridge transformer Tx. The instantaneous loss in the transistors is 1/p² times that of the full-bridge converter, which is less than 1.

When both three-bridge transformers Tx₁ and Tx₂ operate simultaneously, the primary windings of Tx₁ and Tx₂ are in series, while the secondary windings are in parallel. The sum of the secondary current is the inductor current. After calculation, the primary current is

$$\frac{1}{1 + p}$$

times that of the full-bridge transformer Tx. The total instantaneous loss in the primary windings of Tx₁ and Tx₂ is

$$0.5 * \frac{1 + {p}^{2}}{{( 1 + p )}^{2}}$$

times that of the full-bridge transformer Tx₁ which is less than 0.25 times. The instantaneous loss in the primary transistors is

$$\frac{1}{{( 1 + p )}^{2}}$$

times that of the full-bridge converter, which is also less than 0.25 times.

The resistance of the secondary winding of the three-bridge transformers Tx₁ and Tx₂ is half that of the full-bridge transformer Tx. If Tx₁ and Tx₂ operate independently, the instantaneous loss in their respective secondary windings are half that of the secondary-side instantaneous loss in the full-bridge transformer. If Tx₁ and Tx₂ operate simultaneously, the secondary windings of Tx₁ and Tx₂ are in parallel, and the total secondary-side instantaneous loss of the three-bridge transformers is

$$0.5 * \frac{1 + {p}^{2}}{{( 1 + p )}^{2}}$$

times that of the full-bridge transformer, which is less than 0.25 times.

In the traditional full-bridge architecture, when the inductor current is greater than zero and the output voltage and current are in a steady state, based on inductor current balance, it can be obtained:

$$D = \frac{V OUT * N}{V BUS}$$

Where:
VBUS is the direct current supply voltage.
VOUT is the output supply voltage.
N is the turn ratio between the primary and secondary sides of the full-bridge transformer Tx.
D is the equivalent duty cycle of the transformer Tx.

In the fully-integrated mode, when the inductor current is greater than zero and the output voltage and current are in a steady state, based on inductor current balance, it can be obtained:

$$( \frac{V BUS}{{N}_{1}} - V OUT ) * {D}_{1} = ( V OUT - \frac{V BUS}{{N}_{2}} ) * {D}_{2}$$

$${D}_{2} = 1 - {D}_{1}$$

$${N}_{1} = N$$

$${N}_{2} = p N$$

Where:
VBUS is the direct current supply voltage.
VOUT is the output supply voltage.
N, N1 and N2 are the turn ratios between the primary and secondary windings of transformers Tx, Tx₁ and Tx₂.
D₁ and D₂ are the equivalent duty cycles of transformers Tx₁ and Tx₂, respectively.

After simplification, it can be obtained:

$$\begin{matrix}{D}_{1} = \frac{p * D - 1}{p - 1} \\ {D}_{2} = \frac{p}{p - 1} ( 1 - D )\end{matrix}$$

Assuming the transistors' resistive loss in the phase-shift full-bridge architecture is equal to 1, the transistors' resistive loss in the full-bridge architecture, after removing the freewheeling loss, is represented as D. In the three-bridge architecture, in the fully-integrated mode, the transistors' resistive loss is

$${D}_{1} + \frac{{D}_{2}}{{p}^{2}} ,$$

which can be simplified as

$$D + \frac{D - 1}{p} .$$

Since D is less than 1, the transistors' resistive loss of the three-bridge architecture in the fully-integrated mode is even lower than the transistors' resistive loss in the full-bridge architecture after removing the freewheeling loss.

In summary, while occupying a similar overall transformer space (compared to the traditional interleave architecture, which would double the transformer space), both the total primary and secondary resistive losses of three-bridge transformer Tx₁ and Tx₂ are reduced by at least half when compared to the full-bridge transformer. If skin effect and proximity effect are considered, the total resistive loss of the two transformers in the three-bridge converter will be reduced even more due to the reduced number of turns in the windings.

In the dual-way and semi-integrated modes, the total resistive loss of the bridge arm switch transistor in the primary bridge arm circuit of the three-bridge converter has a certain degree of reduction. In the fully-integrated mode, the total resistive loss of the bridge arm switch transistor in the primary bridge arm circuit of the three-bridge converter is even lower than that of the phase-shifted full-bridge architecture after removing the freewheeling loss.

Referring to FIGS. 1 to 6, in an embodiment of the present application, the transformer Tx, of the three-bridge DC-DC converter can still have the same number of turns as the transformer in the full-bridge DC-DC converter, with the primary winding with a turn of 2 kN and the secondary winding with of a turn of 2k. In this case, a magnetic core with half the cross-sectional area can be used, i.e., Ae₁=0.5Ae. Taking into account positive and negative balance of magnetic flux, the formula for calculating the maximum flux B₁ₘₐₓ in the transformer Tx₁ of the three-bridge architecture DC-DC converter is as follows:

$${B}_{1 max} = \frac{( V BUS * {D}_{1} * T )}{2 kN * {Ae}_{1} * 2} = \frac{( V BUS * {D}_{1} * T )}{kN * Ae * 2}$$

Where:
VBUS is the direct current supply voltage,
D₁ is the equivalent duty cycle of the transformer Tx₁,
T is the switching period of the three-bridge DC-DC converter,
2 kN is the number of turns in the primary winding of the transformer Tx₁,
Ae and Ae₁ are the equivalent cross-sectional areas of the transformers Tx and Tx₁, respectively.

When

$${D}_{1} = \frac{D}{2} ,$$

B₁ₘₐₓ=Bₘₐₓ. Since the area of the magnetic core is reduced by half compared to the full-bridge transformer, the winding perimeter of the magnetic core of the transformer Tx₁ is 0.707 times that of the full-bridge transformer Tx. With the same winding specifications, the primary-side and secondary-side resistances can be reduced by approximately 29% in this embodiment. This embodiment utilizes less magnetic material compared to the previous embodiment.

The design of the transformer Tx₂ in this embodiment can refer to the previous embodiment.

In an embodiment, referring to FIG. 1 to FIG. 6, the DC-DC converter operates in an alternate phase-shift full-bridge mode, a dual-way mode, a semi-integrated operation mode, and a fully-integrated mode.

The DC-DC converter further includes a main controller, which is connected to the controlled ends of the bridge arm switches in the M bridge arm circuits. The main controller, during the operation of the DC-DC converter, is configured to control turn on/turn off of the corresponding bridge arm switches in the M bridge arm circuits, allowing the transformer component 20 to operate in one of the alternate phase-shift full-bridge mode, dual-way mode, semi-integrated mode, and fully-integrated mode or a combination of these modes.

In this embodiment, when the DC-DC converter operates in the alternate phase-shift full-bridge mode, dual-way mode, semi-integrated mode, and fully-integrated mode, these four modes have different timing sequences to accommodate various duty cycle applications. The alternate phase-shift full-bridge mode or dual-way mode can be used when the equivalent full-bridge duty cycle (i.e., the duty cycle required in a traditional full-bridge configuration) is relatively small. When the equivalent full-bridge duty cycle is relatively large, the semi-integrated mode or fully-integrated mode can be employed.

In an embodiment, as shown in FIG. 1 to FIG. 6, when M is 3, the three bridge arm circuits include a first bridge arm switch Q11, a second bridge arm switch Q12, a third bridge arm circuit Q21, a fourth bridge arm switch Q22, a fifth bridge arm switch Q31 and a sixth bridge arm switch Q32.

The first bridge arm switch Q11 and the second bridge arm switch Q12 are connected in series, forming a first bridge arm circuit 11.

The third bridge arm switch Q21 and the fourth bridge arm switch Q22 are connected in series, forming a second bridge arm circuit 12.

The fifth bridge arm switch Q31 and the sixth bridge arm switch Q32 are connected in series, forming a third bridge arm circuit 13.

In an embodiment where the transformer component 20 includes (M-1) transformers, when M is 3, the three bridge arm circuits and two transformers form a three-bridge DC-DC converter. The two transformers are transformers Tx₁ and Tx₂.

An end of the primary winding of the transformer Tx₁ is connected to the bridge arm center point of the first bridge arm circuit 11, and the other end of the primary winding of the transformer Tx₁ is connected to the bridge arm center point of the second bridge arm circuit 12.

An end of the primary winding of the transformer Tx₂ is connected to the bridge arm center point of the second bridge arm circuit 12, and the other end of the primary winding of the transformer Tx₂ is connected to the bridge arm center point of the third bridge arm circuit 13.

The various bridge arm switches can be turned on or off based on different levels of the received driving signals. The bridge arm switches are turned on when receiving high-level driving signals and turned off when receiving low-level driving signals. Alternatively, the bridge arm switches are turned on when receiving low-level driving signals and turned off when receiving high-level driving signals. In this embodiment, the explanation is based on the scenario where the bridge arm switches are turned on upon receiving high-level driving signals and turned off upon receiving low-level driving signals. When each bridge arm switch is turned on or turned off, the primary winding forms a current loop with the connected DC power supply through the turned-on bridge arm switch transistor. This allows the DC current from the connected DC power supply to flow through the primary winding, coupling electrical energy to the secondary winding of the transformer component 20. The voltage at secondary winding is then rectified and filtered by the rectification and filtering circuit 30 before being converted to the supply voltage and is output to the loads. This process achieves the conversion and isolation of the DC power supply. When M is greater than 3, the M bridge arm circuits and the (M-1) transformers form the M-bridge DC-DC converter, and the (M1)th bridge arm switch QM1 and the (M2)th bridge arm switch QM2 are connected in series to form the (M1)th bridge arm circuit 1M.

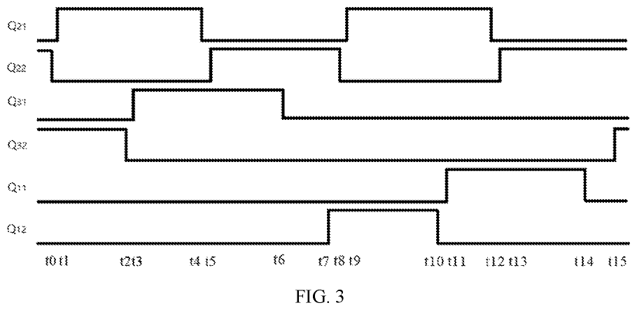

Referring to FIG. 1, FIG. 2 and FIG. 3, in an embodiment, in the alternate phase-shift full-bridge mode, the main controller controls the on/off of the two bridge arm switches in either the first bridge arm circuit 11 or the third bridge arm circuit 13 and ensures that all two bridge arm switches in the other bridge arm circuit are in the off state, when controlling the on/off of the two bridge arm switches in the second bridge arm circuit 12.

In an embodiment, in the alternate phase-shift full-bridge mode, the (M-1) transformers work in sequence at the DC power supply voltage and zero voltage for one or more control periods. In the former part of one control period, the primary-side voltage of one of the transformers is the DC power supply voltage, and in the latter part of one control period, the primary-side voltage of the same transformer is zero. The transformers operate in this manner for one or more periods, with (M-1) transformers operating in sequence.

In an embodiment, in the alternate phase-shift full-bridge mode, within one control period, one of the transformers first works by connecting to the DC power supply through the corresponding bridge arm and then short-circuits both ends of the transformer through the corresponding bridge arm. The transformer operates in this manner for one or more control periods, with (M-1) transformers operating in sequence.

Referring to FIG. 3, FIG. 3 shows the timing diagram of the driving signals received by each bridge arm switch during the alternate phase-shift full-bridge mode. The following analysis is based on the condition that the minimum current through the inductor L1 is greater than zero.

At time t0, prior to time t0, the fourth bridge arm switch Q22 and the sixth bridge arm switch Q32 are in the on state, while the rest of the bridge arm switches are in the off state. When time t0 arrives, the fourth bridge arm switch Q22 turns off, and resonance of the leakage inductance begins. The voltage at the bridge arm center point V2 of the second bridge arm circuit 12 starts to increase.

At time t1, the voltage at the bridge arm center point V2 of the second bridge arm circuit 12 reaches the highest point, and the third bridge arm switch Q21 softly turns on. At this point, the electrical energy is delivered from the primary winding of the transformer Tx₂ to the secondary winding, thereby outputting energy to the outside.

At time t2: the sixth bridge arm switch Q32 turns off, and the voltage at the bridge arm center point V3 of the third bridge arm circuit 13 begins to increase.

At time t3, the voltage at the bridge arm center point V3 of the third bridge arm circuit 13 reaches the highest point, and the fifth bridge arm switch Q31 softly turns on. The transformer Tx₂, the third bridge arm switch Q21, and the fifth bridge arm switch Q31 start entering the freewheeling state.

At time t4, the third bridge arm switch Q21 turns off, and resonance of the leakage inductance begins. The voltage at the bridge arm center point V2 of the second bridge arm circuit 12 starts to decrease.

At time t5, the voltage at the bridge arm center point V2 of the second bridge arm circuit 12 reaches the lowest point, and the fourth bridge arm switch Q22 softly turns on. At this moment, the primary winding of the transformer Tx₂ delivers the electrical energy to the secondary winding, thereby outputting energy to the outside.

At time t6, the fifth bridge arm switch Q31 turns off, and the voltage at the bridge arm center point V3 of the third bridge arm circuit 13 starts to decrease.

Between time t6 and t7, while the transformer Tx₁, the fourth bridge arm switch Q22 and the sixth bridge arm switch Q32 are in the freewheeling state, the sixth bridge arm switch Q32 can be turned on for synchronous rectification or not. If the synchronous rectification is turned on, the sixth bridge arm switch Q32 needs to be turned off before time t8.

At time t7, due to the influence of the voltage at the bridge arm center point V2 of the second bridge arm circuit 12 and the voltage at the bridge arm center point V3 of the third bridge arm circuit 13, the bridge arm center point V1 of the first bridge arm circuit 11 automatically reaches the minimum voltage. At this moment, the second bridge arm switch Q12 is softly turned on.

At time t8, the fourth bridge arm switch Q22 is turned off, and resonance of the leakage inductance begins. The voltage at the bridge arm center point V2 of the second bridge arm circuit 12 starts to increase.

At time t9, the voltage at the bridge arm center point V2 of the second bridge arm circuit 12 reaches the maximum voltage, and the third bridge arm switch Q21 is softly turned on. At this moment, the electrical energy is transferred from the primary winding of transformer Tx, to the secondary winding, thereby outputting the energy to the outside.

At time t10, the second bridge arm switch Q12 is turned off, and then the voltage at the bridge arm center point V1 of the first bridge arm circuit 11 starts to increase.

At time t11, the voltage at the bridge arm center point V1 of the first bridge arm circuit 11 reaches the maximum voltage, and the first bridge arm switch Q11 is softly turned on. The transformer Tx₁, the third bridge arm switch Q21, and the first bridge arm switch Q11 enter the freewheeling state.

At time t12, the third bridge arm switch Q21 is turned off, and resonance of the leakage inductance begins. The voltage at the bridge arm center point V2 of the second bridge arm circuit 12 starts to decrease.

At time t13, the voltage at the bridge arm center point V2 of the second bridge arm circuit 12 reaches the minimum voltage and the fourth bridge arm switch Q22 is softly turned on. At this moment, the electrical energy is delivered from the primary winding of transformer Tx, to the secondary winding, thereby outputting the energy to the outside.

At time t14, the first bridge arm switch Q11 is turned off, and then the voltage at the bridge arm center point V1 of the first bridge arm circuit 11 starts to decrease.

During the freewheeling time of transformer Tx₁, the second bridge arm switch Q12 and the fourth bridge arm switch Q22, which occurs between the time t14 and t15, the second bridge arm switch Q12 can be turned on for synchronous rectification or not. If the synchronous rectification is turned on, the second bridge arm switch Q12 needs to be turned off before time t0.

At time t15, due to the influence of the voltage at the bridge arm center point V2 of the second bridge arm circuit 12 and the voltage at the bridge arm center point V1 of the first bridge arm circuit 11, the center point V3 of the third bridge arm circuit 13 automatically reaches the minimum voltage. The sixth bridge arm switch Q32 is softly turned on.

The above operations are repeated from time t0 to time t15.

If the time applied to the transformer Tx₂ is greater than the remanence reset time of the transformer Tx₁, alternate operations can allow the transformers to reset automatically. No other methods, such as DC-blocking capacitors Cb1, Cb2, or current sensing, are required.

Assuming that the change in the product of positive operating voltage and time of the transformer Tx₁ is VT1, and the change in the product of negative operating voltage and time of the transformer is VT2, the product of voltage and time of the remanence is VT1−VT2. When driven with symmetric positive and negative waveforms, the product of voltage and time of the remanence VT1−VT2 is a small value compared to the change in the product of the positive operating voltage and time VT1 or the change in the product of the negative operating voltage and time VT2. When transformer Tx₂ operates in either a positive or negative direction, as long as it exceeds a reasonable time, it will provide a reset for the transformer Tx₁ in one direction. Therefore, the transformer Tx₁ is always reset. The same principle applies to the transformer Tx₂ as well.

In the above-mentioned embodiment, the time period from t0 to t7 is referred to as Phase A, and the time period from t8 to t15 is referred to as Phase B. The entire working sequence can either follow an A-B-A-B alternating pattern, or it can involve multiple consecutive A phases followed by multiple consecutive B phases. During the time period from t0 to t15, only one pair of the switches (i.e., either the first bridge arm switch Q11 and the second bridge arm switch Q12 or the fifth bridge arm switch Q31 and the sixth bridge arm switch Q32) works, while the other pair is turned off, when the bridge arm switches (i.e., the third bridge arm switch Q21 and the fourth bridge arm switch Q22) are in operation. The operation of the bridge arm switches refers to turn on/off at a specific duty cycle in accordance with the timing of the driving signal.

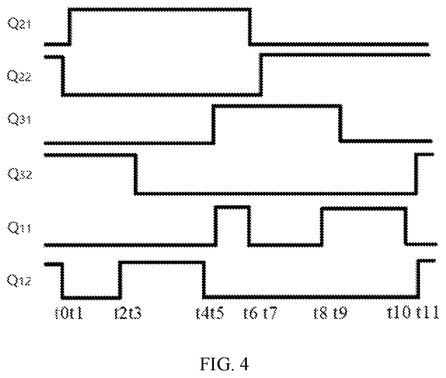

Referring to FIG. 1, FIG. 2, and FIG. 4, in an embodiment, in the dual-way mode, the main controller controls the second bridge arm switch Q12 to turn off first and the fifth bridge arm switch Q31 to turn on later; it also controls the first bridge arm switch Q11 to turn off first and the sixth bridge arm switch Q32 to turn on later.

The main controller controls the second bridge arm switch Q12 to turn on first and the sixth bridge arm switch Q32 to turn off later; it also controls the first bridge arm switch Q11 to turn on first and the fifth bridge arm switch Q31 to turn off later.

In an embodiment, in the dual-way mode, within one control period, the first to the (M−1)th transformers operate sequentially at the DC power supply voltage. Subsequently, the (M-1)th transformer continues to operate at zero voltage. In this embodiment, the transformers are counted from right to left, with the first transformer being the one depicted as Tx₂, and the second transformer being the one depicted as Tx₁.

In an embodiment, in the dual-way mode, within one control period, the (M-1) transformers initiate a cycle starting from any one of the transformers and operate sequentially by connecting them to the DC power supply through the corresponding bridge arm. At the end of the control period, the last transformer continues to freewheel by short-circuiting both ends through the corresponding bridge arm.

In an embodiment, In the dual-way mode, when switching to the operation of the last transformer, the last two transformers are simultaneously connected to the DC power supply and operate.

Referring to FIG. 4, FIG. 4 illustrates the timing diagram of the driving signals received by each bridge arm switch in the dual-way mode. The following analysis is based on the condition where the minimum current through the inductor L1 is greater than zero.

At time t0, the second bridge arm switch Q12 and the fourth bridge arm switch Q22 are turned off. Resonance of the leakage inductance begins, and the voltage at the bridge arm center point V2 of the second bridge arm circuit 12 starts to increase.

At time t1, in response to that the voltage at the bridge arm center point V2 of the second bridge arm circuit 12 reaches the maximum voltage, the third bridge arm switch Q21 is turned on. The secondary winding of the transformer Tx₂ outputs energy externally after rectification.

At time t2, the second bridge arm switch Q12 is turned on, and the secondary winding of the transformer Tx₁ outputs energy externally after rectification.

At time t3, the sixth bridge arm switch Q32 is turned off. After the sixth bridge arm switch Q32 is turned off, residual energy from the leakage inductance and magnetizing current charges the bridge arm center point V3 of the third bridge arm circuit 13.

At time t4, the second bridge arm switch Q12 is turned off.

At time t5, after a dead time, the first bridge arm switch Q11 and the fifth bridge arm switch Q31 are turned on. The transformer Tx₁, the first bridge arm switch Q11 and the third bridge arm switch Q21 enter the freewheeling state.

At time t6, the first bridge arm switch Q11 and the third bridge arm switch Q21 are turned off. Resonance of the leakage inductance begins, and the voltage at the bridge arm center point V2 of the second bridge arm circuit 12 starts to decrease.

At time t7, after the voltage at the bridge arm center point V2 of the second bridge arm circuit 12 reaches the minimum voltage, the fourth bridge arm switch Q22 is turned on. The secondary winding of the transformer Tx₂ outputs energy externally after rectification.

At time t8, the first bridge arm switch Q11 is turned on, and the secondary winding of the transformer Tx₁ outputs energy externally after rectification.

At time t9, the fifth bridge arm switch Q31 is turned off. After the fifth bridge arm switch Q31 is turned off, residual energy from the leakage inductance and magnetizing current discharges at the bridge arm center point V3 of the third bridge arm circuit 13.

At time t10, the first bridge arm switch Q11 is turned off.

At time t11, after a dead time, the second bridge arm switch Q12 and the sixth bridge arm switch Q32 are turned on. The transformer Tx₁, the second bridge arm switch Q12 and the fourth bridge arm switch Q22 enter the freewheeling state.

The above operations are repeated from time t0 to t11.

In the above embodiment, the main controller controls the timing of driving signals according to the described sequence, and turns on/off at a certain duty cycle.

Referring to FIGS. 1, 2, 5 and 6, in an embodiment, in the semi-integrated mode or the fully-integrated mode, the main controller controls the third bridge arm switch Q21 to be turned on first and the first bridge arm switch Q11 to be turned off later; it also controls the fourth bridge arm switch Q22 to be turned on first and the second bridge arm switch Q12 to be turned off later.

The main controller controls the second bridge arm switch Q12 to be turned on first and the sixth bridge arm switch Q32 to be turned off later; it also controls the first bridge arm switch Q11 to be turned on first and the fifth bridge arm switch Q31 to be turned off later.

The main controller controls the fifth bridge arm switch Q31 to be turned on first and the fourth bridge arm switch Q22 to be turned on later; it also controls the sixth bridge arm switch Q32 to be turned on first and the third bridge arm switch Q21 to be turned on later.

In an embodiment, in the semi-integrated mode, within one control period, the first to the (M-1)th transformers operate sequentially at the DC power supply voltage. Afterward, the (M−1) transformers work simultaneously.

In an embodiment, in the semi-integrated mode, within one control period, the (M-1) transformers start a cycle from any one transformer, sequentially connecting to the DC power supply through their corresponding bridge arms. Afterward, the (M-1) transformers work in serial simultaneously.

In an embodiment, in the semi-integrated mode, when switching to the operation of the last transformer, the last two transformers are simultaneously connected to the DC power supply and operate.

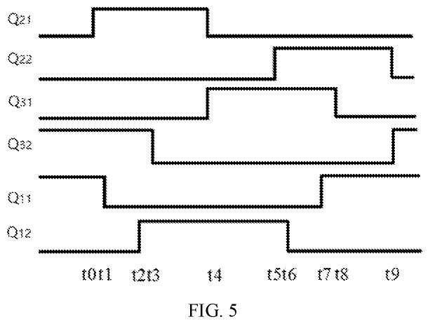

Referring to FIG. 5, FIG. 5 illustrates the timing diagram of the driving signals received by each bridge arm switch in the semi-integrated mode. The following analysis is based on the condition where the minimum current through inductor L1 is greater than zero. In this embodiment, the transformers are counted from right to left, with the first transformer being the one depicted as Tx₂, and the second transformer being the one depicted as Tx₁.

At time t0, the third bridge arm switch Q21 is turned on, and the transformer Tx₂ independently outputs energy externally after rectification.

At time t1, the first bridge arm switch Q11 is turned off, and the magnetizing current discharges at the bridge arm center point V1 of the first bridge arm circuit 11.

At time t2, the second bridge arm switch Q12 is turned on. At this moment, the transformer Tx₁ starts to output energy externally after rectification, depending on turns ratio of Tx₂.

At time t3, the sixth bridge arm switch Q32 is turned off. Between t3 and t4, the remaining energy from the leakage inductance and the magnetizing current of Tx₂ is utilized to charge at the bridge arm center point V3 of the third bridge arm circuit 13, reducing loss when the fifth bridge arm switch Q31 is turned on.

At time t4, the third bridge arm switch Q21 is turned off, and the fifth bridge arm switch Q31 is turned on. Between t4 and t5, the transformers Tx₁ and Tx₂ jointly output energy externally after rectification.

At time t5, the fourth bridge arm switch Q22 is turned on. At this moment, the transformer Tx₂ independently outputs energy externally after rectification.

At time t6, the second bridge arm switch Q12 is turned off, and the magnetizing current charges at the bridge arm center point V1 of the first bridge arm circuit 11.

At time t7, the first bridge arm switch Q11 is turned on, and the transformer Tx₁ starts to output energy externally after rectification, depending on turns ratio of Tx₂.

At time t8, the fifth bridge arm switch Q31 is turned off. Between t8 and t9, the residual energy and magnetizing current of leakage inductance of the transformer Tx₂ are maximally utilized to discharge at the bridge arm center point V3 of the third bridge arm circuit 13, reducing loss when the sixth bridge arm switch Q32 is turned on.

At time t9, the fourth bridge arm switch Q22 is turned off, and the sixth bridge arm switch Q32 is turned on. Between t9 and t0, the transformers Tx₁ and Tx₂ jointly output energy externally after rectification.

The above operations are repeated from time t0 to t9.

In this mode, Tx₂→Tx₁→(Tx₁ and Tx₂ work together), there is no freewheeling state where the transformer outputs zero voltage and has output current. In the above-mentioned embodiment, the main controller controls the timing of driving signals as described above, and performs turn-on/off with a certain duty cycle.

In an embodiment, in the fully-integrated mode, within one control period, the first to the (M-1)th transformers operate sequentially at the DC power supply voltage.

In an embodiment, in the fully-integrated mode, within one control period, the (M-1) transformers initiate a cycle starting from any one of the transformers. They sequentially connect to the DC power supply through their corresponding bridge arms.

In an embodiment, in the fully-integrated mode, the control period is adjusted based on changes in the input voltage and the duty cycle of each transformer to ensure that the maximum magnetic flux in any one of the (M-1) transformers does not exceed the maximum allowable value of the magnetic material. As the product of the input voltage and the duty cycle increases, the control period is reduced to prevent magnetic saturation and ensure that the maximum magnetic flux in the magnetic material does not exceed the allowable value.

In an embodiment, in the fully-integrated mode, when switching to the operation of the last transformer, the last two transformers are simultaneously connected to the DC power supply and operate.

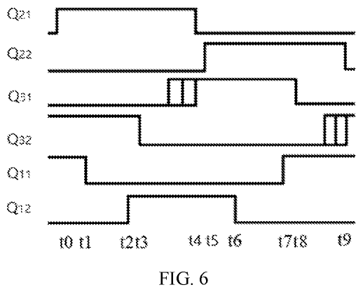

Referring to FIG. 6, the DC-DC converter operates in the fully-integrated mode. FIG. 6 depicts the timing diagram of the driving signals received by each bridge arm switch in the fully-integrated mode. The following analysis is based on the condition where the minimum current through the inductor L1 is greater than zero.

At time t0, in response to that the voltage at the bridge arm center point V2 of the second bridge arm circuit 12 reaches the maximum, the third bridge arm switch Q21 is turned on. The transformer Tx₂ independently outputs energy externally after rectification.

At time t1, the first bridge arm switch Q11 is turned off, and the magnetizing current discharges at the bridge arm center point V1 of the first bridge arm circuit 11.

At time t2, the second bridge arm switch Q12 is turned on. At this moment, the transformer Tx₁ starts to output energy externally after rectification, depending on turns ratio of Tx₂.

At time t3, the sixth bridge arm switch Q32 is turned off. Between t3 and t4, the residual energy of leakage inductance and magnetizing current of Tx₂ is utilized maximally to charge the bridge arm center point V3 of the third bridge arm circuit 13, reducing loss when the fifth bridge arm switch Q31 is turned on. The fifth bridge arm switch Q31 is turned on at a certain time between t3 and t4.

At time t4, the third bridge arm switch Q21 is turned off, and resonance begins. The voltage at the bridge arm center point V2 of the second bridge arm circuit 12 starts to decrease.

At time t5, the voltage at the bridge arm center point V2 of the second bridge arm circuit 12 reaches the minimum voltage, and the fourth bridge arm switch Q22 is turned on. The transformer Tx₂ independently outputs energy externally after rectification.

At time t6, the second bridge arm switch Q12 is turned off, and the magnetizing current charges the bridge arm center point V1 of the first bridge arm circuit 11.

At time t7, the first bridge arm switch Q11 is turned on, and the transformer Tx₁ starts to output energy externally after rectification, depending on turns ratio of Tx₂.

At time t8, the fifth bridge arm switch Q31 is turned off. Between t8 and t9, the residual energy of leakage inductance and magnetizing current of Tx₂ is maximally utilized to discharge the bridge arm center point V3 of the third bridge arm circuit 13, reducing loss when the sixth bridge arm switch Q32 is turned on. The sixth bridge arm switch Q32 is turned on at a certain time between t8 and t9.

At time t9, the fourth bridge arm switch Q22 is turned off, and resonance begins. The bridge arm center point voltage V2 of the second bridge arm circuit 12 starts to increase.

The above operations are repeated from time t0 to t9.

In this mode, the transformers Tx₂ and Tx₁ work alternately at the DC power supply voltage, avoiding a freewheeling state where a transformer outputs zero voltage and has output current, resulting in no load current freewheeling loss. In the above-mentioned embodiment, the main controller controls the timing of driving signals as described above, and performs turn on/off with a certain duty cycle.

Refer to FIG. 1 to FIG. 6, in an embodiment, the transformer component 20 includes (M-1) transformers Tx₁˜Tx_{M-1}. Among these (M-1) transformers, there can be two or more transformers with different turns ratio. Each of these transformers includes two primary winding connection ends.

One of the primary winding connection ends of the Nth transformer is connected to the bridge arm center point of the Nth bridge arm circuit, and the other primary winding connection end is connected to the bridge arm center point of the (N+1)th bridge arm circuit. In this configuration, 1≤N≤(M-1). The main controller controls the on and off of the corresponding bridge arm switches in the M bridge arm circuits, allowing the transformer component 20 to operate in one of the alternate phase-shift full-bridge mode, the dual-way mode, the semi-integrated mode, and fully-integrated mode or a combination of these modes.

In the alternate phase-shift full-bridge mode, the (M-1) transformers work in sequence with the DC power supply voltage and zero voltage applied to their primary sides for one or more control periods.

In the dual-way mode, during one control period, after the first transformer to the (M−1)th transformer operates in sequence with the DC power supply voltage applied to their primary sides, the (M-1)th transformer continues to operate under zero voltage conditions.

In the semi-integrated mode, during one control period, after the first transformer to the (M-1)th transformer operates in sequence with the DC power supply voltage applied to their primary sides, the (M-1) transformers work simultaneously.

In the fully-integrated mode, during one control period, the first transformer to the (M−1)th transformer operates in sequence with the DC power supply voltage applied to their primary sides.

The DC-DC converter also includes a main controller, which is connected to the controlled ends of the bridge arm switches in the M bridge arm circuits. The main controller is configured to control the on and off of the corresponding bridge arm switches in the M bridge arm circuits during the operation of the DC-DC converter. This control enables the transformer component to operate in one of the alternate phase-shift full-bridge mode, the dual-way mode, the semi-integrated mode, and the fully-integrated mode or a combination of these modes.

In the alternate phase-shift full-bridge mode, (M-1) transformers are paired with M bridge arm circuits, and the (M-1) transformers work sequentially in an alternate phase-shift full-bridge manner for one or more control periods. Specifically, within one cycle, the first transformer operates in an alternate phase-shift full-bridge mode for one or more control periods, and then the second transformer operates for one or more control periods, continuing in this manner until the (M-1)th transformer is completed. In the next cycle, the first transformer seamlessly takes over from the (M-1)th transformer, and this pattern continues in a loop.

In the dual-way mode, within one control period, the first to (M-1)th transformers operate sequentially at the direct current power supply voltage, and then the (M-1)th transformer Tx_{M-1} continues in zero voltage mode. In the next control period, the first transformer seamlessly takes over from the (M-1)th transformer to start working.

In the semi-integrated mode, within one control period, the first to (M-1)th transformers operate sequentially at the direct current power supply voltage, and then the (M-1) transformers Tx₁˜Tx_{M-1} operate simultaneously (only the upper switch of the first bridge arm circuit and the lower switch of the last bridge arm circuit are turned on, or only the lower switch of the first bridge arm circuit and the upper switch of the last bridge arm circuit are turned on). In the next control period, the first transformer seamlessly takes over to start working. This mode does not have any freewheeling loss.

In the fully-integrated mode, within one control period, the first to (M-1)th transformers operate sequentially at the direct current power supply voltage. In the next control period, the first transformer seamlessly takes over from the (M-1)th transformer to start working. This mode does not have any freewheeling loss.

Referring to FIG. 1 to FIG. 6, in the above-described embodiments, under an M-bridge architecture where M is greater than or equal to three, the DC-DC converter can also be provided with DC-blocking capacitors. Each DC-blocking capacitor is connected in series with the primary winding of the transformer that requires magnetic balancing. The number of DC-blocking capacitors can be set based on the number of transformers. In an embodiment of the DC-DC converter with (M-1) transformers, for example, when M is equal to 3, a DC-blocking capacitor Cb1 can be provided between the bridge arm center point V1 of the first bridge arm circuit 11 and one of the primary winding connection ends of the transformer Tx₁, or between the bridge arm center point V2 of the second bridge arm circuit 12 and the other primary winding connection end of the transformer Tx₁. Similarly, a DC-blocking capacitor can also be provided between one of the primary winding connection ends of the transformer Tx₂ and the bridge arm center point V2 of the second bridge arm circuit 12 or between the other primary winding connection end of the transformer Tx₂ and the bridge arm center point V3 of the third bridge arm circuit 13. The (M−1) transformers can be connected to M half-bridges with or without DC-blocking capacitors.

The DC-DC converter described in the present application is not limited to the specific modes and working methods mentioned above. For example, in the present application, the DC-DC converter can include at least one of the following modes: independent phase-shift full-bridge mode, independent full-bridge mode, alternate full-bridge mode, alternate phase-shift full-bridge mode, dual-way mode, semi-integrated mode, and fully-integrated mode.

In the standalone phase-shift full-bridge mode, only one of the (M-1) transformers operates. Within one control period, the transformer first operates by connecting to the DC power supply through the corresponding bridge arm. Then, the transformer operates by short-circuiting both ends of the transformer through the corresponding bridge arm.

In the standalone full-bridge mode, only one of the (M-1) transformers operates within one control period. The transformer first connects to the DC power supply through the corresponding bridge arm, and then all the bridge arms connected to the transformer are turned off, causing the input end of the transformer to float.

In the alternate full-bridge mode, within one control period, one of the (M-1) transformers first connects to the DC power supply through the corresponding bridge arm, and then all the bridge arms connected to the transformer are turned off, causing the input end of the transformer to float. The transformer operates in this manner for one or more control periods, and the (M-1) transformers work in a cyclic sequence.

In the alternate phase-shift full-bridge mode, within one control period, one of the transformers operates first by connecting to the DC power supply through the corresponding bridge arm, and then operates by short-circuiting the two ends of the transformer through the corresponding bridge arm. The transformer operates in this manner for one or more control periods, and then the (M-1) transformers cyclically operate in sequence.

In the dual-way mode, within one control period, the (M-1) transformers initiate a cycle starting from any one of the transformers. They operate sequentially by connecting to the DC power supply through the corresponding bridge arm. At the end of the control period, the last transformer continues to freewheel by short-circuiting both ends through the corresponding bridge arm.

In the semi-integrated mode, within one control period, the (M-1) transformers initiate a cycle starting from any one of the transformers. They operate sequentially by connecting to the DC power supply through the corresponding bridge arms. At the end of the control period, the (M−1) transformers work in series.

In the fully-integrated mode, within one control period, the (M-1) transformers initiate a cycle starting from any one transformer. They operate sequentially by connecting to the DC power supply through their corresponding bridge arms.

The DC-DC converter also includes a main controller. The main controller is connected to the controlled ends of the bridge arm switches in each of the M bridge arm circuits. The main controller is configured to control the on and off of the corresponding bridge arm switches in the M bridge arm circuits during the operation of the DC-DC converter, to enable the transformer component to work in one of standalone full-bridge mode, standalone bridge arm mode, alternate full-bridge mode, alternate phase-shift full-bridge mode, dual-way mode, semi-integrated mode, and fully-integrated mode or a combination of these modes.

In this embodiment:

In the dual-way mode, semi-integrated mode, or fully-integrated mode, when switching to the last transformer for operation, the last two transformers are simultaneously connected to the DC power supply and operate.

In the fully-integrated mode, the control period is adjusted based on the changes in the input voltage and the duty cycle of each transformer to ensure that the maximum magnetic flux of any one of the (M-1) transformers does not exceed the maximum allowable value of the magnetic material.

Switching between any two modes has a hysteresis associated with the variation in the equivalent full-bridge duty cycle.

Switching from the alternate phase-shift full-bridge mode to the semi-integrated mode has a higher equivalent full bridge duty cycle than that of switching from the semi-integrated mode to the alternate phase-shift full-bridge mode.

Switching from dual-way mode to semi-integrated mode has a higher equivalent full bridge duty cycle than that of switching from semi-integrated mode to dual-way mode.

Switching from semi-integrated mode to fully-integrated mode has a higher equivalent full bridge duty cycle than that of switching from the fully-integrated mode to the semi-integrated mode.

The present application also proposes a power supply device that includes the aforementioned DC-DC converter.

The detailed structure of the DC-DC converter can refer to the above-mentioned embodiments, and is not repeated here. It can be understood that since the above-mentioned DC-DC converter is used in the power supply device of the present application, the embodiments of the power supply device in the present application include all the technical solutions of the embodiments of the DC-DC converter mentioned above, and the achieved technical effects are also completely identical, which are not repeated here.

The above description are only optional embodiments of the present application and does not limit the scope of the present application. Under the concept of the present application, all the equivalent structural transformations made using the contents of the description and drawings of the present application, directly or indirectly applied in other related technical fields, are included in the scope of the present application.

What is claimed is:

1. A DC-DC converter, comprising:
a power input end, configured to be connected to a direct current (DC) power supply;
a power output end, configured to output power;
M bridge arm circuits, wherein input ends of the M bridge arm circuits are connected to the power input end, and M is an integer greater than 1;
a transformer component, comprising (M-1) transformers, wherein the (M-1) transformers are provided with at least 2 transformers with different turns ratios, each of the transformers comprises one primary winding and at least one secondary winding, wherein the one primary winding comprises two primary winding connection ends, one of the primary winding connection ends of the Nth transformer is connected to a bridge arm center point of the Nth bridge arm circuit, and the other primary winding connection end of the Nth transformer is connected to the bridge arm center point of the (N+1)th bridge arm circuit, where 1≤N≤(M-1); and
a rectification and filtering circuit, wherein input ends of the rectification and filtering circuit are connected to secondary winding connection ends of the transformer component, an output end of the rectification and filtering circuit is connected to the power output end, and the rectification and filtering circuit shares a common filtering inductor; wherein
the secondary windings of the transformer of the transformer component are paralleled after rectification by the rectification and filtering circuit;
the M bridge arm circuits and the transformer component are configured to convert the input DC voltage into the required voltages on secondary windings of the transformer component, the required voltages are rectified and filtered by the rectification and filtering circuit, and the filtered voltage is output to the power output end, where M≥3;
one transformer is operating at a DC power supply voltage and delivering energy externally, the two primary winding connection ends of the transformer adjacent to the one transformer are short-circuited through the bridge arm circuits, the transformer adjacent to the one transformer and one bridge arm circuit connected to the transformer are in a state of magnetizing current freewheeling, turn-off of the corresponding switch in the bridge arm circuit is controlled and the magnetizing current of the adjacent transformer is utilized to charge and discharge the parasitic capacitor at the floating end.

2. The DC-DC converter of claim 1, wherein a turn-off time of the corresponding switch of the bridge arm circuit is controlled according to the magnetizing current of the adjacent transformer.

3. A power supply device, comprising the DC-DC converter of claim 1.

4. A DC-DC converter, comprising:
a power input end, configured to be connected to a DC power supply;
a power output end, configured to output power;
M bridge arm circuits, wherein input ends of the M bridge arm circuits are connected to the power input end, and M is an integer greater than 1;
a transformer component, comprising (M-1) transformers, wherein the (M-1) transformers are provided with at least two transformers with different turns ratios, each of the transformers comprises one primary winding and at least one secondary winding, wherein the one primary winding comprises two primary winding connection ends, one of the primary winding connection ends of the Nth transformer is connected to a bridge arm center point of the Nth bridge arm circuit, and the other primary winding connection end of the Nth transformer is connected to the bridge arm center point of the (N+1)th bridge arm circuit, where 1≤N≤(M-1); and
a rectification and filtering circuit, wherein input ends of the rectification and filtering circuit are connected to secondary winding connection ends of the transformer component, an output end of the rectification and filtering circuit is connected to the power output end, the rectification and filtering circuit shares a common filtering inductor, wherein
the secondary windings of the transformer of the transformer component are paralleled after rectification by the rectification and filtering circuit;
the M bridge arm circuits and the transformer component are configured to convert the input DC voltage into the required voltages on secondary windings of the transformer component, the required voltages are rectified and filtered by the rectification and filtering circuit, and the filtered voltage is output to the power output end, where M≥3,
the DC-DC converter operates in a fully-integrated mode, in the fully-integrated mode, the first to the (M-1)th transformers operate sequentially at a voltage of the DC power supply within one control period, or
in the fully-integrated mode, within one control period, the (M-1) transformers initiate a cycle starting from any one transformer, and sequentially connect to the DC power supply through their corresponding bridge arms.

5. The DC-DC converter of claim 4, wherein in the fully-integrated mode, the control period is adjusted based on changes in an input voltage and a duty cycle of each transformer to ensure that the maximum magnetic flux in any one of the (M-1) transformers does not exceed the maximum allowable value of magnetic material.

6. The DC-DC converter of claim 4, wherein in the fully-integrated mode, when switching to the operation of the last transformer, the last two transformers are simultaneously connected to the DC power supply.

7. A power supply device, comprising the DC-DC converter of claim 4.

8. A DC-DC converter, comprising:
a power input end, configured to be connected to a DC power supply;
a power output end, configured to output power;
M bridge arm circuits, wherein input ends of M bridge arm circuits are connected to the power input end, and M is an integer greater than 1;
a transformer component, comprising (M-1) transformers, wherein the (M-1) transformers are provided with at least 2 transformers with different turns ratios, each of the transformers comprises one primary winding and at least one secondary winding, wherein one primary winding comprises two primary winding connection ends, one of the primary winding connection ends of the Nth transformer is connected to a bridge arm center point of the Nth bridge arm circuit, and the other primary winding connection end of the Nth transformer is connected to the bridge arm center point of the (N+1)th bridge arm circuit, where 1≤N≤(M-1); and
a rectification and filtering circuit, wherein input ends of the rectification and filtering circuit are connected to secondary winding connection ends of the transformer component, an output end of the rectification and filtering circuit is connected to the power output end, the rectification and filtering circuit shares a common filtering inductor, wherein
the secondary windings of the transformer of the transformer component are paralleled after rectification by the rectification and filtering circuit,
the M bridge arm circuits and the transformer component are configured to convert the input DC voltage into the required voltages on secondary windings of the transformer component, the required voltages are rectified and filtered by the rectification and filtering circuit, and the filtered voltage is output to the power output end, wherein M≥3.

9. The DC-DC converter of claim 8, wherein, during one control period, multiple transformers operate alternately to reduce the maximum magnetic flux of a single transformer.

10. The DC-DC converter of claim 8, wherein magnetic cores of two transformers in the transformer component are connected together.

11. The DC-DC converter of claim 8, wherein the DC-DC converter operates in a proximity mode,
in the proximity mode, during one control period, when the voltage at the power output end falls between rectified voltages of any two of the (M-1) transformers, these two transformers operate alternately; and/or,
in the proximity mode, during one control period, when the voltage at the power output end is lower than the rectified voltages of all transformers among the (M-1) transformers, the transformer with the minimum rectified voltage operates.

12. The DC-DC converter of claim 8, wherein two adjacent transformers with different turns ratio of the (M-1) transformers are simultaneously connected to the DC power supply, the transformer with the large turns ratio conducts all or most of the current,
maintain the state for a period of time, so that one bridge arm circuit, which is connected to the primary winding of the transformer with the large turns ratio, is turned off with smaller current to decrease the switching loss.

13. The DC-DC converter of claim 8, wherein the DC-DC converter operates in a semi-integrated mode, in the semi-integrated mode, within one control period, the first to the (M-1)th transformers operate sequentially at the DC power supply voltage, afterward, the (M-1) transformers work simultaneously; or
in the semi-integrated mode, within one control period, the (M-1) transformers initiate a cycle starting from any one of the transformers and sequentially connect to the DC power supply through the corresponding bridge arms, and all the (M-1) transformers work in serial at the end of the control period.

14. The DC-DC converter of claim 8, wherein the DC-DC converter operates in a dual-way mode, in the dual-way operation, within one control period, the (M-1) transformers start a cycle from any one of the transformers, and sequentially connect to the DC power supply through the corresponding bridge arm, and at the end of the control period, the last transformer short-circuits at both ends and freewheels through the corresponding bridge arm.

15. The DC-DC converter of claim 8, wherein the DC-DC converter operates in a standalone phase-shift full-bridge mode, in the standalone phase-shift full-bridge mode, only one of the (M−1) transformers operates, within one control period, the transformer first connects to the DC power supply through the corresponding bridge arm, and then short-circuits both ends of the transformer through the corresponding bridge arm.

16. The DC-DC converter of claim 15, wherein among all the transformers where the voltage output after rectification is greater than the voltage at the power output end, the transformer currently in operation has the highest turns ratio.

17. The DC-DC converter of claim 8, wherein the DC-DC converter has at least one of the standalone phase-shift full-bridge mode, the standalone full-bridge mode, the alternate full-bridge mode, the alternate phase-shift full-bridge mode, the dual-way mode, the semi-integrated mode, and the fully-integrated mode,
in the standalone phase-shift full-bridge mode, only one of the (M-1) transformers operates, within one control period, the transformer first operates by connecting to the DC power supply through the corresponding bridge arm, and then operates by short-circuiting both ends of the transformer through the corresponding bridge arm;
in the standalone full-bridge mode, only one of the (M-1) transformers operates, within one control period, the transformer first operates by connecting to the DC power supply through the corresponding bridge arm, and then all the bridge arms connected to the transformer are turned off to make the input end of the transformer floating;
in the alternate full-bridge mode, within one control period, one of the (M-1) transformers operates first by connecting to the DC power supply through the corresponding bridge arm, then all the bridge arms connected to the transformer are turned off to make the input end of the transformer floating, the transformer operates in this manner for one or more control periods, and all the (M-1) transformers operate sequentially in a cyclic manner;
in the alternate phase-shift full-bridge mode, within one control period, one of the transformers operates first by connecting to the DC power supply through the corresponding bridge arm and then operates by short-circuiting both ends of the transformer through the corresponding bridge arm, the transformer operates in this manner for one or more control periods, and all the (M-1) transformers operate sequentially in a cyclic manner;
in the dual-way mode, within a control period, (M-1) transformers initiate a cycle from any one of the transformers, and sequentially operating by connecting to the DC power supply through the corresponding bridge arm, at the end of the control period, the last transformer freewheels by short-circuiting both ends through the corresponding bridge arm;
in the semi-integrated mode, within one control period, the (M-1) transformers start a cycle from any one of the transformers and sequentially operating by connecting to the DC power supply through the corresponding bridge arm, afterward, the (M-1) transformers operate in series simultaneously;
in the fully-integrated mode, within one control period, the (M-1) transformers initiate a cycle starting from any one transformer and sequentially connect to the DC power supply through their corresponding bridge arms,
the DC-DC converter further comprises a main controller, the main controller is connected to controlled ends of the bridge arm switches in each of the M bridge arm circuits, respectively; the main controller is configured to control the on/off of the corresponding bridge arm switches in the M bridge arm circuits during the operation of the DC-DC converter, allowing the transformer component to operate in one of the standalone phase-shift full-bridge mode, standalone full-bridge mode, alternate full-bridge mode, alternate phase-shift full-bridge mode, dual-way mode, semi-integrated mode, and fully-integrated mode or a combination thereof.

18. A power supply device, comprising the DC-DC converter of claim 8.

19. A power supply device, comprising the DC-DC converter of claim 9.

20. A power supply device, comprising the DC-DC converter of claim 11.

21. A power supply device, comprising the DC-DC converter of claim 16.

22. A power supply device, comprising the DC-DC converter of claim 17.
